(19) United States
(12) Patent Application Publication
(10) Pub. No.: US 2008/0249840 A1
(43) Pub. Date: Oct. 9, 2008

(54) SYSTEM AND METHOD FOR INCREASING DEMAND FOR PERISHABLE GOODS AT A POINT-OF-SALE LOCATION UTILIZING LOCATION-BASED COMMUNICATION

(75) Inventor: Bernard G. Koether, Fort Lauderdale, FL (US)

Correspondence Address: EDWARDS ANGELL PALMER & DODGE LLP, P.O. BOX 55874, BOSTON, MA, 02205, US

(73) Assignee: Technology Licensing Corporation, Fort Lauderdale, FL (US)

(21) Appl. No.: 12/054,360

(22) Filed: Mar. 24, 2008

Related U.S. Application Data
(60) Provisional application No. 60/896,513, filed on Mar. 23, 2007.

(51) Int. Cl. G06Q 10/00; G06Q 30/00

(52) U.S. Cl. 705/10

(57) ABSTRACT

In accordance with the invention, a method for increasing demand for a perishable item utilizing production capacity planning in a perishable asset production facility, such as a restaurant situation which allows for flexibility and production forecastability to determine a necessary number of new customers to balance demand with production capacity is provided. The determination is made as a function of raw material, labor availability, work in process, and food in holding cabinets (inventory) awaiting purchase. By monitoring this production capacity and the trend of sales, by utilizing probability theory, and expected sales in a given time interval necessary demand to optimize sales is predicted. It is then determined how large a geographical area containing potential customers, as function of predicted response rates, is to be notified in order for expected demand to meet expected production. The geographical area relative to the facility is determined and a message is sent to potential customers within the geographic area notifying them of the availability of the perishable items.

### CROSS-REFERENCE TO RELATED APPLICATIONS

This application claims priority under 35 U.S.C. 119(e) to U.S. Provisional Patent Application No. 60/896,513, filed Mar. 23, 2007.

### BACKGROUND OF THE INVENTION

This application is directed to driving demand for perishable goods at the point of sale, such as at restaurants, supermarkets, bakeries, meat wholesalers, butchers, wine manufacturers, fruit wholesalers, product markets retail and wholesale, as well as non food items that have a “valuable life cycle” that is predictable, and related to inventory availability and monitored by a data base system, and more particularly, for targeting purchasers of the perishable goods as a function of customer geographic location in real time.

It is known in the art to predict product demand for goods at retail, wholesale, or processor facilities based on past experience. With the advent of computer technology, modeling has been developed to predict demand for goods. However, at locations where goods are perishable, such as restaurants, bakeries, supermarkets, food processing facilities, the model can be upset by anything from an unforeseen competing event, weather, traffic jams, the absence of regular customers for any unexpected reasons or errors made in the production process; any combination of which could leave the entity with excess perishable inventory. If the goods are not sold within their perishable life, they must be discarded and no revenue is recognized by the owner.

Furthermore, restaurants are staffed with personnel and provided with equipment to meet optimum predicted sales at peak traffic times. Accordingly, at traditional rush hours such as lunch time and dinnertime the restaurant is able to operate at or near full capacity. However, there are down times between the peak hours of sale during which the inventory of equipment, personnel and foodstuffs is under utilized. Although the predictive models may be able to predict these down times, it is still inefficient to idle equipment or send staff home for an interim time period. Conversely, if demand unpredictably slows, then food in process will go to waste.

By the same token, the use of location-based services or applications for portable devices, most commonly in a cellular phone network, has become widespread. These are services or applications that are provided to subscribers based on their current geographic location. One such application may help identify for the phone user certain commercial establishments within a predetermined area of a cellular phone, or may even respond to queries from a cellular phone user as to local places of interest, such as restaurants or shops.

Furthermore, in some instances where the location based applications have been created to direct traffic to a specific location, it has been on an ad hoc basis with no real use of predictive analysis to optimize the efficiency of the use of staff, equipment and perishable goods.

Accordingly, a methodology and system that overcome the shortcomings of the prior art is desired.

### BRIEF SUMMARY OF THE INVENTION

In accordance with the invention, a method for increasing demand for a perishable item utilizing production capacity or inventory creation planning which allows for flexibility and production forecastability to determine a necessary number of new customers to balance demand with production capacity is provided. The determination is made as a function of raw material, labor availability, work in process, and perishable items in storage, (inventory) awaiting purchase. By monitoring this production capacity and the trend of sales, by utilizing probability theory, and expected sales in a given time interval necessary demand to optimize sales is predicted. It is then determined how large a geographical area containing potential customers, as function of predicted response rates, is to be notified in order for expected demand to meet expected production. The geographical area relative to the facility is determined and a message is sent to potential customers within the geographic area notifying them of the availability of the perishable items.

In a preferred embodiment, the process is iterated at predetermined intervals. Furthermore, to incentivize the customers, the message to the customer may include directions to the facility; (a bakery, supermarket, butchery, winery, or restaurant, or any such facility that stores, produces, or holds perishable assets), time limited coupons, coupons in general or the like. In one preferred embodiment the perishable item is food.

### BRIEF DESCRIPTION OF THE DRAWINGS

FIG. 1 is a schematic drawing of a location based application system in accordance with the invention; and

FIG. 2 is a flowchart for the method of driving demand in accordance with the invention.

### DETAILED DESCRIPTION OF THE INVENTION

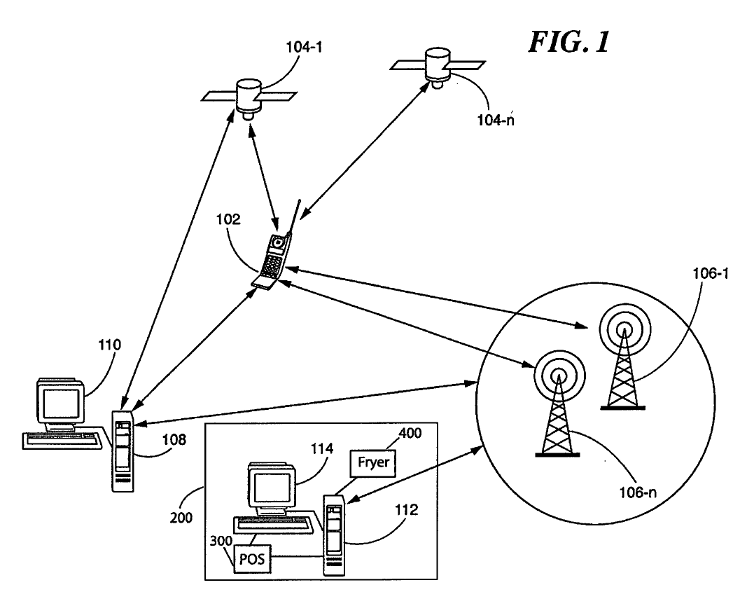

Reference is now made to FIG. 1 wherein a network based ALI Solution for use in accordance with the invention is shown for automatically identifying a geographic location of a cellular phone, such as cell phone 102, by way of non-limiting example, utilizing fixed base stations 106-1, 106-N. The cellular phone 102 can be a wireless PDA cell phone, laptop computer or any other device incorporating suitable processing and communication circuitry. The fixed base stations 106-1, 106-N can be in communication with a server 108 which can calculate a geographic location of the cellular phone 102.

Server 108 communicates with the base stations 106-1, 106-N using any suitable means. For example, a conventional telephone network, high-speed data line, wireless link, or a combination of the foregoing may be used. Base stations 106-1, 106-N can provide a data link between the cellular phone 102 and the server 108. The server can be controlled by workstation 110 or similar user interface device.

Either in addition to, or instead of, a Global Positioning System (GPS) and associated processing circuitry/software may be utilized. The GPS System may be incorporated into each cellular phone 102 and such system can use a plurality of GPS satellites 104-1, 104-N to independently determine the geographic location of the device. The GPS based location information thus obtained can be forwarded to the server 108 through the one or more base stations 106-1, 106-N.

Location server 108 is also in communication with an application server 112. Application server 112 processes the location data received from server 108 in accordance with the invention as discussed below. Application server 112 communicates with cellular phone 102 utilizing the cellular network. Server 112 also communicates with server 108 by any known communication method, including, but not limited to, internet, telephone, circular network, wireless or the like.

It should be noted that servers 108, 112 are utilized in a preferred invention, because in the preferred embodiment, application 112 for ease of description, is located at the point of sale facility 200. However, the process discussed below can be performed at a single server across a distributed network, or any system there between.

A perishable asset facility, 200 includes at least one food preparation processor embodied for ease of description as a single device 400 such as a cooker, chiller, cutter, baking oven, fryer, or a processing system that ferments or ages a product to a time based sensitive prime condition for best sale date, and at least one point of sale device 300 such as a cash register, a credit card terminal, bio-recognition device, or any other device capable of billing a personal or business account for payment of goods. Food production monitoring devices such as the Kitchen Advisor™ manufactured by Food Automation—Service Techniques, Inc. are known in the art to monitor food preparation equipment. Server 112 can monitor fryer 400. By monitoring fryer 400, server 112 may determine how much food is being made and calculate and maintain a running inventory of available food.

As is known from SCK Direct Inc.'s Smart Commercial Kitchen® Solutions, it is known to monitor point of sale device 300. Server 112 determines how much product has been sold, i.e., consumed as a function of monitored sales. By comparing the perishable asset production to the perishable assets sold or (consumption), server 112, may determine a current perishable asset supply and projected perishable asset or food supply. Furthermore, by monitoring one or more perishable asset production devices, such as ovens and fryers 400 at a perishable asset production facility such as a bakery or restaurant 200, server 112 may determine what percentage of capacity is currently being used.

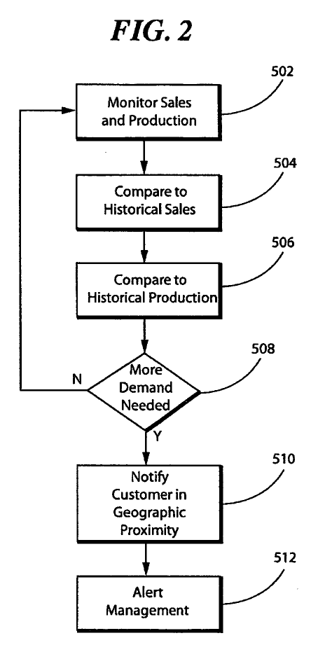

Generally, server 112 utilizes information to determine an anticipated theoretical production quantity, (if all available production assets were utilized such as multiple ovens or fryers,) if usage were increased from an under utilized state, or potential perishable waste if the food determined to be available (inventory) is in fact not sold. Reference is now made to FIG. 2, which is an algorithm for driving customers to the facility, such as a bakery, supermarket or restaurant 200 to match demand to food currently in preparation.

As discussed above, in a first step 502, server 112 monitors the order processing system of the perishable asset generating facility, such as a bakery, supermarket or restaurant 200 including the point of sale device 300 and food production facilities exemplified by fryer 400. Current production and available capacity is determined. In a step 504, the current data for production, work in process, available raw materials and production capacity is compared to historical sales at the same facility, or a comparable facility model in a step 504. In a step 506, the current production data is compared to a historical production data at the current facility and/or historical production data of a comparable facility model.

In a step 508, server 112 applies predictive algorithms to dynamically determine the necessary demand to meet the production forecast. The production forecast is a function of raw material, labor availability, work in process (perishable assets or food currently being cooked, prepared, conditioned or aged) and the inventory of such perishable assets held in finished or semi finished state in storage refrigerators, or heated holding cabinets or displays. Utilizing current trend sales and probability theory, server 112 calculates the expected sales in a given time interval and then determines whether or not more demand is needed to prevent waste of inventory as the goods are perishable. If no more demand is needed, then the process is repeated at step 502.

In a preferred embodiment, the capacity planning algorithm calculates the individual capacity of each appliance based upon its physical capacity, labor available to load and operate the appliance, the condition of the appliance (whether or not maintenance is required such as a shortening change, a burner cleaning or the like) the available raw materials and their prep time or any such set of factors related to the production of the perishable asset. As an added feature, server 112 could provide directions to the staff providing what perishable asset such as a food item to cook, when and where.

Because the items have an optimum sale date and/or are perishable if the goods are not sold in a timely manner they become wasted assets, and are destroyed (food) or no longer capable of use (tickets). If it is determined in step 508 that more demand is needed, then server 112 utilizes a predictive model as discussed above to determine the number of necessary additional customers to whom a message of food availability should be sent. Not all recipients of the message will respond, however a predictive model of the percentage of respondents (based on theory, historical data or the like) may be used to determine the time period and the radius of the geographical boundary to ensure sufficient potential customers are notified. Therefore, part of the algorithm performed in step 508 is to determine how wide a geographical area to contact and how much of a price break, if any (new customers needed=zero), to provide as a function of the demand need and the probability a contacted consumer responds.

The customers are notified in a step 510. The notification takes the form of a reminder that the person associated with cellular phone 102 is within X blocks of the facility where the perishable asset resides, such as a restaurant, hotel, supermarket, 200 or a coupon or price break advertisement may be forwarded to cellular phone 102 along with the address to generate more demand. Directions to restaurant 200 may also form part of the message. In this way, the system automatically determines that more demand is needed to avoid spoilage of the food being processed and takes steps to provide sufficient demand. This process is preferably repeated at predetermined intervals such as every fifteen minutes by way of non-limiting example.

This methodology can also utilize this type of predictive model not only to react to a lack of demand, but also to try to increase demand for supply that has not yet been provided for. In other words, as discussed above, there are slow periods between rush hours in which production capacity is under utilized. The determination in step 508 can use a predictive model to determine what number of customers can be driven to a facility at known prices or other incentives, and send a notice to all users of a communication device such as cell phone 102 within the determined geographical area. It will then be determined what capacity would need to be utilized to meet the newly generated demand. In a step 512, management is alerted that the notification has gone out so that it may plan accordingly to utilize the necessary fryers 400 and/or labor if they are currently idled.

As can be seen the data processing methodology automatically generates a signal that work in process is not anticipated to be sold and therefore determines that fresh demand is necessary to fill unit production capacity. The notice in step 510, if associated with an incentive for the customer may have an expiration time to incentivize the customer to proceed as quickly as possible to restaurant 200 and better normalize the production needs.

It is contemplated, that the customers utilizing the contacted cell phones 102 have opted into the system. (Some geographic markets allow broadcast to the general public and in those cases, specific software algorithms are provided to facilitate this transaction.) Therefore, the perishable asset producer such as a restaurant 200 creates an affinity program or a members only program. It is also possible to track which cellular phone numbers respond most often to the notification in step 510 and tailor future programs accordingly.

For ease of explanation, a restaurant 200 was illustrated as having a single server 112, a representative fryer 400 and a single point of sale system 300. However, as discussed above, server 112 can be remotely monitoring the point of sale network 300 or fryer 400 as well as perform the location based application. The location based application functionality may be bifurcated and remote from restaurant 200. It is well understood within the art that fryer 400 is representative of ovens, freezers, refrigerators, chillers and holding stations all of which can be monitored to better define the predictive algorithm utilized in step 508. Fryer 400 and point of sale device 300 are also representative of a plurality of processors 400 and point of sale device 300 all monitored by one or more servers 112.

A restaurant was used by way of example. However, this system and methodology is applicable to any establishment selling a perishable good, such as wine, tobacco, food stuffs or any system in which there is a time limit on the use of the end product, such as beach umbrellas at the end of the day at a resort, souvenirs at a sporting event, tickets to an event or an airplane, or the like. Preparation processor may respectively be a shelf life monitor, humidor, oven or the like, or reservations provisioning computer. Furthermore, cell phones were used by way of example, but any mobile communication device such as a pager, personal geographic location and messaging may be utilized.

Thus, while there have been shown, described and pointed out novel features of the present invention as applied to preferred embodiments thereof. It will be understood that various omissions, substitutions, and changes in the form and detail are contemplated and may be made by those skilled in the art without departing from the spirit and scope of the invention. It is the intention therefore, to be limited only as indicated by the scope of the claims appended hereto. It is also to be understood that the following claims are intended to cover all of the generic and specific features of the invention herein described and all statements of the scope of the invention, which, as a matter of the language, might be said to fall there between.

What is claimed as new and desired to be protected by Letters Patent of the United States is:

1. A method for increasing demand for a perishable item which is at least one of produced, inventoried and sold at a facility comprising:
monitoring the sales and production of the perishable item at a point of sale of the perishable item;
determine whether more demand is needed for the perishable item to prevent waste of the perishable item;
determining a geographic area necessary to contain sufficient customers to meet a determined demand necessary to prevent waste of the perishable item;
notifying customers within the geographical area at a respective portable communication device of the availability and location of the perishable items.

2. The method of claim 1, wherein demand is determined as a function of current sales, historic sales and at least one of the historic sales and historic production.

3. The method of claim 2, further comprising the step of determining whether to increase demand for the perishable item by increasing the geographic area necessary to meet an increased demand, and the decision to increase demand is determined as a function of available capacity to produce additional quantities of the perishable item at the facility.

4. The method of claim 1, wherein the determination regarding more demand includes determining a time period during which demand is needed and a geographic area corresponding to the number of potential respondents to the notification.

5. The method of claim 1, where demand is determined as a function of a raw material capacity, a labor availability, a work in process value, and a perishable item inventory at the facility.

6. The method of claim 1, wherein the determination of whether more demand is needed is performed at predetermined intervals.

7. The method of claim 1, wherein the perishable item is food.

8. A system for increasing demand of a perishable item comprising:
a mobile communication device associated with at least one potential customer;
at least one preparation processor located at a point of sale of the perishable item;
at least one point of sale apparatus located at the point of sale of the perishable item; and
a predictive server operatively communicating with the preparation processor and point of sale apparatus, and monitoring one or more sales made at the point of sale apparatus and the processing of the perishable item by the preparation processor and determining whether more demand is needed for the perishable item to prevent wastage of the perishable item, the predictive server determining a demand for the perishable item, determining a geographic area necessary to contain a sufficient number of customers having one or more communication devices to meet a determined demand; and sending a signal regarding the location and availability of the perishable item to one or more mobile communication devices located within the geographic area if it is determined that such sufficient number of customers is not at the point of sale.

9. A system of claim 8, wherein said predictive server determines demand for the perishable item as a function of a capacity of the preparation processor to produce additional quantities of the perishable item.

10. A system of claim 8, further comprising a database; historic sales data being stored in the database, said server determining current sales as a function of an output at least one point of sale apparatus, and determining a demand for the perishable item as a function of at least one of the historic sales, current sales, and historic production the at least one preparation processor.

11. A system of claim 8, wherein said predictive server further monitors the amount of raw material available for preparation of the perishable item, an amount of labor available for the preparation of the perishable item, a work in process value corresponding to the amount of the perishable item being produced by at least one preparation processor; the predictive server calculating a perishable item inventory as a function of monitoring the point of sale apparatus, and at least one preparation processor, and determining a demand for a perishable item as a function of the raw material capacity, the labor availability, the work in process value and the perishable item inventory.
